(19) United States
(12) Patent Application Publication
(10) Pub. No.: US 2002/0107166 A1
(43) Pub. Date: Aug. 8, 2002

(54) Liquid detergent compositions

(76) Inventors: Timothy C. Morris, Morton, PA (US); Michael B. Hansberry, Plymouth Meeting, PA (US); Stephen F. Gross, Souderton, PA (US); Charles B. Allen, Clinton, NJ (US); Robert J. Valesky, Hatboro, PA (US)

Correspondence Address: COGNIS CORPORATION, 2500 RENAISSANCE BLVD., SUITE 200, GULPH MILLS, PA, 19406

(21) Appl. No.: 09/929,999

(22) Filed: Aug. 15, 2001

Related U.S. Application Data
(60) Provisional application No. 60/227,167, filed on Aug. 23, 2000.
(60) Provisional application No. 60/290,897, filed on May 15, 2001.

(51) Int. Cl. C11D 17/00; C11D 3/38

(52) U.S. Cl. 510/421; 510/424; 510/470; 510/463

(57) ABSTRACT

An aqueous laundry detergent composition is comprised of: (1) from about 0.5% by weight to about 30% by weight of a nonionic surfactant of the formula I

R₁O(R₂O)_{b}(Z)ₐ I

wherein R₁ is a monovalent organic radical having from about 6 to about 30 carbon atoms; R₂ is a divalent alkylene radical having from 2 to 4 carbon atoms; Z is a saccharide residue having 5 or 6 carbon atoms; b is a number having a value from 0 to about 12; a is a number having a value from 1 to about 6; (2) from about 0.5% by weight to about 30% by weight of an anionic surfactant selected from the group consisting of an alkyl ether sulfate having a degree of ethoxylation of from 1 to about 20, a linear alkyl benzene sulfonate, an alpha olefin sulfonate, a secondary alkane sulfonate, and an alkyl sulfate; and (3) from about 2.0% by weight to about 15% by weight of a water soluble builder.

### CROSS-REFERENCE TO RELATED APPPLICATIONS

This application claims priority of copending provisional application serial No. 60/227,167, filed on Aug. 23, 2000 and copending provisional application serial No. 60/290,897, filed on May 15, 2001, the entire contents of each of which is incorporated herein by reference.

### BACKGROUND OF THE INVENTION

Liquid detergent products, particularly those formulated for consumer laundry cleaning, are based primarily on surfactants to provide most of the cleaning benefit. Alkaline builders (e.g. sodium carbonate and sodium silicate) which are commonly used in detergent powders and which provide additional cleaning benefits are minimized or are avoided altogether in liquid detergent compositions due to solubility limitations, and surfactant incompatibility problems. Alkyl polyglycosides, which exhibit excellent stability in the presence of alkaline salts, are used widely in alkaline liquid cleaning compositions formulated for industrial and institutional cleaning applications; e.g. I&I laundry detergent and hard surface cleaners. U.S. Pat. No. 5,631,216 teaches the stability and performance benefits of alkyl polyglycosides in these cleaning compositions.

### BRIEF SUMMARY OF THE INVENTION

One aspect of the present invention relates to an aqueous laundry detergent composition comprising: (1) from about 0.5% by weight to about 30% by weight of a nonionic surfactant of the formula I

R₁O(R₂O)_{b}(Z)ₐ I

wherein R₁ is a monovalent organic radical having from about 6 to about 30 carbon atoms; R₂ is a divalent alkylene radical having from 2 to 4 carbon atoms; Z is a saccharide residue having 5 or 6 carbon atoms; b is a number having a value from 0 to about 12; a is a number having a value from 1 to about 6; (2) from about 0.5% by weight to about 30% by weight of an anionic surfactant selected from the group consisting of an alkyl ether sulfate having a degree of ethoxylation of from 1 to about 20, a linear alkyl benzene sulfonate, an alpha olefin sulfonate, a secondary alkane sulfonate, and an alkyl sulfates; (3) from about 2.0% by weight to about 15% by weight of a water soluble builder.

Optionally, the composition can contain from about 0.01 to about 2.0% by weight of an essential oil such as, for example, a botanical compound. The aqueous laundry detergent compositions according to the invention perform as well as un-built surfactant based liquid laundry compositions containing 30-70% higher levels of surfactant actives. This ability to utilize builders is realized through the unique solubility/hydrotroping properties of alkyl polyglycoside. Other benefits of alkyl polyglycosides include: effective detergency for laundry cleaning applications; synergy with other surfactants to achieve a more balanced soil/stain removal profile; high solubility/compatibility/hydrotroping affect of alkyl polyglycosides in the presence of alkaline salts and the ability to form a stable product which is under stress due to the presence of alkaline salts and essential oils therein. The presence of essential oils in a built system would require the use of a costly hydrotrope system in order to maintain a single liquid phase. The present invention, however, reduces or eliminates the need for such costly hydrotropes.

The aqueous laundry detergent compositions according to the invention exhibit an unexpected increase in high temperature cloud point and stability with increasing total surfactant amounts. Normally, an increase in the total amount of surfactant in the presence of alkaline salts results in a decrease in the cloud point of a nonionic surfactant based composition. Accordingly, another aspect of the present invention relates to a method of making a stable, highly built liquid detergent comprising adding a mixture of an alkyl polyglycoside and anionic surfactant selected from the group consisting of an alkyl ether sulfate having a degree of ethoxylation of from 1 to about 20, a linear alkyl benzene sulfonate, an alpha olefin sulfonate, a secondary alkane sulfonate, and an alkyl sulfate to a composition comprised of a nonionic surfactant and a builder to increase the cloud point and product stability wherein the weight ratio of the sum of the alkyl polyglycoside and anionic surfactant to the nonionic surfactant is from about 2 to about 4 and the weight ratio of the anionic surfactant to the alkyl polyglycoside is from about 0.5 to about 2.0.

### DETAILED DESCRIPTION OF THE INVENTION

The alkyl polyglycosides that can be used in the compositions and processes according to the invention are those having the formula I

R₁O(R₂O)_{b}(Z)ₐ I

wherein R₁ is a monovalent organic radical having from about 6 to about 30 carbon atoms; R₂ is a divalent alkylene radical having from 2 to 4 carbon atoms; Z is a saccharide residue having 5 or 6 carbon atoms; b is a number having a value from 0 to about 12; a is a number having a value from 1 to about 6. Preferred alkyl polyglycosides which can be used in the compositions according to the invention have the formula I wherein Z is a glucose residue and b is zero. Such alkyl polyglycosides are commercially available, for example, as APG®, GLUCOPON®, PLANTAREN® or AGRIMUL® surfactants from Cognis Corporation, Ambler, Pa., 19002. Examples of such surfactants include but are not limited to:

1. GLUCOPON® 220 Surfactant—an alkyl polyglycoside in which the alkyl group contains 8 to 10 carbon atoms and having an average degree of polymerization of 1.5.

2. GLUCOPON® 225 Surfactant—an alkyl polyglycoside in which the alkyl group contains 8 to 10 carbon atoms and having an average degree of polymerization of 1.7.

3. GLUCOPON® 600 Surfactant—an alkyl polyglycoside in which the alkyl group contains 12 to 16 carbon atoms and having an average degree of polymerization of 1.4.

4. GLUCOPON® 625 Surfactant—an alkyl polyglycoside in which the alkyl group contains 12 to 16 carbon atoms and having an average degree of polymerization of 1.6.

5. APG® 325 Surfactant—an alkyl polyglycoside in which the alkyl group contains 9 to 11 carbon atoms and having an average degree of polymerization of 1.6.

6. PLANTAREN® 2000 Surfactant—an alkyl polyglycoside in which the alkyl group contains 8 to 16 carbon atoms and having an average degree of polymerization of 1.4.

7. PLANTAREN® 1300 Surfactant—an alkyl polyglycoside in which the alkyl group contains 12 to 16 carbon atoms and having an average degree of polymerization of 1.6.

8. AGRIMUL® PG 2067 Surfactant—an alkyl polyglycoside in which the alkyl group contains 8 to 10 carbon atoms and having an average degree of polymerization of 1.7.

Other examples include alkyl polyglycoside surfactant compositions which are comprised of mixtures of compounds of formula I as described in U.S. Pat. Nos. 5,266,690 and 5,449,763, the entire contents of both of which are incorporated herein by reference. A preferred alkyl polyglycoside is one in which the alkyl group contains 12 to 16 carbon atoms and having an average degree of polymerization of 1.6. The amount of alkyl polyglycoside that can be used in the compositions according to the invention is from about 0.5% by weight to about 30% by weight. A preferred amount being from about 1% to about 10%.

The anionic surfactant according to the invention is selected from the group consisting of a linear alkyl benzene sulfonate, an alpha olefin sulfonate, a secondary alkane sulfonate, and an alkyl sulfate.

Preferably, the anionic surfactant is a compound of the formula II:

R(EO)_{N}]⁻_{M}X^{+M} II

wherein R is a linear or branched alkyl group having from 8 to 20 carbon atoms or an alkylphenyl group wherein the alkyl group is octyl or nonyl; N is a number from 0 to 12; M is 1 or 2 and X is an alkali or alkaline earth metal cation or a monoethanolammonium, diethanolammonium or triethanolammonium cation. Examples of such anionic surfactants include, but are not limited to, the sodium salts of fatty alcohol ether sulfates wherein the average degree of ethoxylation is from about 1 to about 7, the ammonium, monoethanolammonium, diethanolammonium or triethanolammonium salts of fatty alcohol ether sulfates wherein the average degree of ethoxylation is from about 1 to about 7, the sodium salts of ethoxylated octyl or nonyl phenol sulfates wherein the average degree of ethoxylation is from about 1 to about 10. Particularly preferred anionic surfactants are the sodium salts of fatty alcohol ether sulfates wherein the average degree of ethoxylation is from about 1 to about 4. The amount of anionic surfactants that can be used in the compositions according to the invention is from about 0.5% by weight to about 30% by weight. A preferred amount being from about 1% to about 15%.

The builder according to the invention can be any material that enhances or maintains the cleaning efficiency of a surfactant. Builders have a number of functions, principally inactivation of water hardness. Other functions of builders are to supply alkalinity to assist cleaning by neutralizing acidic soils, to provide buffering so alkalinity is maintained at an effective level, to aid in keeping removed soil from re-depositing during washing, and to emulsify oily and greasy soils. (Reference: Soaps & Detergents, A Handbook of Industry Terms, Third Edition—June, 1987). Examples of builders include, but are not limited to, alkali metal carbonates such as sodium, lithium, and potassium carbonate; alkali metal sesquicarbonates such as sodium bicarbonates, sodium silicates (0.5 to 3.22 Na₂O:SiO₂ ratio), sodium ortho phosphate, sodium pyrophosphate, sodium tripolyphosphate, Na EDTA, Sodium NTA (Nitrilotriacetate), Borax, Sodium Borate, and sodium citrate. A preferred builder is sodium carbonate. The amount of water soluble builder that can be used in the compositions according to the invention is from about 2% by weight to about 15% by weight. A preferred amount being from about 3% to about 10%.

The essential oil optionally employed in the composition of the present invention is preferably a botanical compound. Examples of suitable botanical compounds include but are not limited to: chamomile extract, tea tree oil, green tea extract, passion flower extract, aloe barbadensis extract, juniper communis extract, clover extract, extract of hazel, extract of sage, and any other botanical compounds known in the art for imparting fragrance. It should be noted, however, that other types of essential oils which are not botanical such as, for example, musk oil, may also be used without departing from the spirit of the invention.

The essential oil component will typically be present in the composition in preferred amounts of at least about 0.01% by weight; at least about 0.05% by weight; at least about 0.1% by weight; at least about 0.2% by weight; at least about 0.5% by weight, at least about 1.0% by weight, at least about 1.5% by weight; at least about 2.0% by weight, all weights being based on the total weight of the composition. In a particularly preferred embodiment, the essential oil will be present in the composition in an amount of from about 0.2 to 0.8% by weight, based on the weight of the composition.

The detergent composition according to the invention can also contain one or more additional nonionic surfactants. Such surfactants include, but are not limited to, alkoxylated linear alcohols and alkoxylated alkyl phenols such as ethoxylated and/or ethoxylated-propoxylated octyl and nonyl phenols and fatty ethanolamides.

Typically, the total active surfactants in the detergent compositions according to the invention will be from about 3% to about 30% by weight based on the total weight of the detergent composition with water making up the remainder after the addition of the carbonate salt.

The detergent composition according to the invention can also contain any additional additives that may be necessary such as brighteners and the like.

In the method of making a stable, highly built liquid detergent, the alkyl polyglycoside is a compound of the formula I as defined above. The anionic surfactant is selected from the group consisting of an alkyl ether sulfate having a degree of ethoxylation of from 1 to about 20, a linear alkyl benzene sulfonate, an alpha olefin sulfonate, a secondary alkane sulfonate, and an alkyl sulfate. The weight ratio of the sum of the alkyl polyglycoside and the anionic surfactant to the nonionic surfactant (alkyl polyglycoside+anionic surfactant)/nonionic surfactant) is from about 2 to about 4. The weight ratio of the anionic surfactant to the alkyl polyglycoside (anionic surfactant/alkyl polyglycoside) is from about 0.5 to about 2.0.

The preferred anionic surfactant is a compound of the formula II as defined above.

The following examples are meant to illustrate but not to limit the invention.

### EXAMPLES

| | 1 | 2 | Un-built |
|---|---|---|---|
| | Wt. % | Wt. % | Wt. % |
| C12-14 alkyl polyglycoside 1.6 DP | 1.5 | 1.3 | — |
| C12-14 Ether Sulfate 2-3 EO (ES) | 2.2 | 1.7 | — |
| Nonyl Phenol Ethoxylate 9 EO (NPE) | — | 1.1 | 5.6 |
| Sodium alkyl benzene sulfonate (LAS) | — | — | 2.0 |
| Sodium Carbonate | 5.0 | 5.0 | 0.6 |
| Sodium Chloride | — | — | — |
| chamomile extract | 0.5 | 0.5 | 0.5 |
| Water | Qs | Qs | Qs |
| Active Surfactant | 3.7 | 4.1 | 7.6 |

In soil/stain removal tests, Compositions 1 and 2 performed equal to a typical low active Liquid Laundry Detergent based on NPE/LAS at 7.6% active surfactant and a very low carbonate level. Compositions 1 and 2 were stable at room temperature and under high/low temperature conditions. Due to the low surfactant active content of these compositions and the use of an inexpensive builder, i.e. sodium carbonate, these formulations are relatively low cost compared to un-built higher surfactant active formulations. Composition 2 was the best overall in terms of cost performance, stability and ability to reach the target viscosity for this type of product. By replacing the alkyl polyglycoside in these formulations with the other surfactants to achieve the same cost or actives levels, the formulation was not stable to moderate or high temperature conditions without the use of a hydrotrope.

These same compositions can be concentrated up to higher actives/higher carbonate systems, if desired.

Performance (Tergitometer)/Stability Data:

| | Liquid | | |
|---|---|---|---|
| | Laundry | | |
| | Formula | Composition 1 | Composition 2 |
| Description | 7.6% actives* | 3.7% actives* | 4.1 actives* |
| | Un-built | 5% Na | 5% Na |
| | | Carbonate | Carbonate |
| Surfactants | NPE/LAS | Alkyl | Alkyl |
| | | polyglycoside/ | polyglycoside/ES |
| | | ES | /NPE |
| Stability/ | | | |
| Properties | | | |
| Cloud pt | >140 F | >140 F | >140 F |
| Viscosity | 110 cps | >110 cps | 120 cps |
| Detergency | 50.8 | 49.4 | 51.1 |
| (delta R units**) | | | |

*actives represent total surfactant actives content of composition
**Sum of delta R units for dust-sebum, clay and olive soils on cotton and polyester cotton test fabrics

The data in the following table shows the increasing cloud point with increasing total surfactant actives wherein the weight ratio of the sum of the alkyl polyglycoside and the anionic surfactant to the nonionic surfactant is about 2.7. STANDAPOL® ES-2 is sodium laureth sulfate (2-EO). The APG® surfactant was GLUCOPON® 625 Surfactant. All surfactant % weights (%wt) are as active surfactant.

| | Control | A | B | C | D |
|---|---|---|---|---|---|
| COMPONENT | % wt | % wt | % wt | % wt | % wt |
| Water | 72.4 | 68 | 63.7 | 59.3 | 55 |
| EDTA | 0.2 | 0.2 | 0.2 | 0.2 | 0.2 |
| Brightener | 0.1 | 0.1 | 0.1 | 0.1 | 0.1 |
| C₁₂₋₁₅ (EO)₇OH | 2.2 | 2.7 | 3.1 | 3.6 | 4.0 |
| APG ® Surfactant | 2.6 | 3.2 | 3.75 | 4.3 | 4.8 |
| STANDAPOL ® ES-2 | 3.35 | 4.0 | 4.75 | 5.45 | 6.15 |
| Na polyacrylate | 0.1 | 0.1 | 0.1 | 0.1 | 0.1 |
| Preservative | 0.1 | 0.1 | 0.1 | 0.1 | 0.1 |
| Coloring | 0.2 | 0.2 | 0.2 | 0.2 | 0.2 |
| Sodium carbonate | 6 | 6 | 6 | 6 | 6 |
| Totals | 100 | 100 | 100 | 100 | 100 |
| Total surfactant | 8.15 | 10.0 | 11.7 | 13.4 | 15.0 |
| Cloud point (° F.) | 140 | 151 | 167 | 156 | 165 |

What is claimed is:

1. An aqueous laundry detergent composition comprising: (1) from about 0.5% by weight to about 30% by weight of a nonionic surfactant of the formula I
R₁O(R₂O)_{b}(Z)ₐ I
wherein R₁ is a monovalent organic radical having from about 6 to about 30 carbon atoms; R₂ is a divalent alkylene radical having from 2 to 4 carbon atoms; Z is a saccharide residue having 5 or 6 carbon atoms; b is a number having a value from 0 to about 12; a is a number having a value from 1 to about 6; (2) from about 0.5% by weight to about 30% by weight of an anionic surfactant selected from the group consisting of an alkyl ether sulfate having a degree of ethoxylation of from 1 to about 20, a linear alkyl benzene sulfonate, an alpha olefin sulfonate, a secondary alkane sulfonate, and an alkyl sulfate; (3) from about 2.0% by weight to about 15% by weight of a water soluble builder.

2. The aqueous detergent of claim 1 wherein the alkyl polyglycoside of formula I is one in which the alkyl group contains 12 to 16 carbon atoms and having an average degree of polymerization of 1.6.

3. The aqueous detergent of claim 1 wherein the anionic surfactant is a compound of the formula II
R(EO)_{N}]⁻_{M}X^{+M} II
wherein R is a linear or branched alkyl group having from 8 to 20 carbon atoms or an alkylphenyl group wherein the alkyl group is octyl or nonyl, N is a number from 0 to 12; M is 1 or 2 and X is an alkali or alkaline earth metal cation or an ammonium, a monoethanolammonium, diethanolammonium or triethanolammonium cation.

4. The aqueous detergent of claim 3 wherein in the compound of formula II, R is a C₁₂₋₁₄ alkyl group, X is a sodium ion, M is 1 and N is 2.

5. The aqueous detergent of claim 1 wherein the builder is a carbonate, silicate, phosphate, borate or a citrate salt.

6. The aqueous detergent of claim 5 wherein the carbonate is sodium carbonate.

7. The aqueous detergent of claim 1 further comprising from about 0.2 to about 0.8% by weight of an essential oil.

8. The aqueous detergent of claim 7 wherein the essential oil is a botanical compound.

9. The aqueous detergent of claim 8 wherein the botanical compound is chamomile extract, tea tree oil, green tea extract, passion flower extract, aloe barbadensis extract, juniper communis extract, clover extract, extract of hazel, or extract of sage.

10. An aqueous laundry detergent composition comprising: (1) from about 1% by weight to about 10% by weight of a nonionic surfactant of the formula I
R₁O(R₂O)_{b}(Z)ₐ I
wherein R₁ is a alkyl radical having from about 12 to about 14 carbon atoms; Z is a saccharide residue having 6 carbon atoms; b is 0; a is about 1.6; (2) from about 1% by weight to about 15% by weight of an anionic surfactant of the formula II
R(EO)_{N}]⁻_{M}X^{+M} II
wherein R is an alkyl group having from 12 to 14 carbon atoms, N is 2, M is 1 and X is a sodium cation; (3) from about 3% by weight to about 10% by weight sodium carbonate salt; and (4) from about 0.2 to about 0.5% by weight of an essential oil, all weights being based on the total weight of the composition, and wherein the total active surfactant amount is from about 3% to about 30% by weight, based on the total composition weight.

11. A method of making a stable, highly built liquid detergent comprising adding a mixture comprised of: (1) an alkyl polyglycoside of the formula I
R₁O(R₂O)_{b}(Z)ₐ I
wherein R₁ is a monovalent organic radical having from about 6 to about 30 carbon atoms; R₂ is a divalent alkylene radical having from 2 to 4 carbon atoms; Z is a saccharide residue having 5 or 6 carbon atoms; b is a number having a value from 0 to about 12; a is a number having a value from 1 to about 6 and (2) an anionic surfactant selected from the group consisting of an alkyl ether sulfate having a degree of ethoxylation of from 1 to about 20, a linear alkyl benzene sulfonate, an alpha olefin sulfonate, a secondary alkane sulfonate, and an alkyl sulfates to a composition comprised of a nonionic surfactant and a builder to increase the cloud point and product stability wherein the weight ratio of the sum of the alkyl polyglycoside and the anionic surfactant to the nonionic surfactant is from about 2 to about 4 and the weight ratio of the anionic surfactant to the alkyl polyglycoside is from about 0.5 to about 2.0.

12. The method of claim 11 wherein the alkyl polyglycoside of formula I is one in which the alkyl group contains 12 to 16 carbon atoms and having an average degree of polymerization of 1.6.

13. The method of claim 11 wherein the alkyl ether sulfate is a compound of the formula II
R(EO)_{N}]⁻_{M}X^{+M} II
wherein R is a linear or branched alkyl group having from 8 to 20 carbon atoms or an alkylphenyl group wherein the alkyl group is octyl or nonyl, N is a number from 0 to 12; M is 1 or 2 and X is an alkali or alkaline earth metal cation or an ammonium, a monoethanolammonium, diethanolammonium or triethanolammonium cation.

14. The method of claim 11 wherein in the compound of formula II, R is a C₁₂₋₁₄ alkyl group, X is a sodium ion, M is 1 and N is 2.

15. The method of claim 11 wherein the builder is a carbonate, silicate, phosphate, borate or a citrate salt.

16. The method of claim 15 wherein the carbonate is sodium carbonate.

17. The method of claim 11 wherein the liquid detergent is further comprised of from about 0.2 to about 0.8% by weight of an essential oil.

18. The method of claim 17 wherein the essential oil is a botanical compound.

19. The method of claim 18 wherein the botanical compound is chamomile extract, tea tree oil, green tea extract, passion flower extract, aloe barbadensis extract, juniper communis extract, clover extract, extract of hazel, or extract of sage.
